(19) United States
(12) Patent Application Publication
(10) Pub. No.: US 2025/0284013 A1
(43) Pub. Date: Sep. 11, 2025

(54) CALIBRATION DEVICE, MEDICAL IMAGE CAPTURING SYSTEM, AND CALIBRATION METHOD

(71) Applicant: FUJIFILM Corporation, Tokyo (JP)

(72) Inventor: Kazuma YOKOI, Tokyo (JP)

(73) Assignee: FUJIFILM Corporation, Tokyo (JP)

(21) Appl. No.: 19/070,695

(22) Filed: Mar. 5, 2025

(30) Foreign Application Priority Data
Mar. 7, 2024 (JP) 2024-035388

(51) Int. Cl. G01T 7/00

(52) U.S. Cl. CPC G01T 7/005

(57) ABSTRACT

Provided are a calibration device, a medical image capturing system, and a calibration method that can easily acquire calibration data of a photon-counting detector. A calibration device is a calibration device that is used to acquire calibration data of a photon-counting detector that outputs an electrical signal corresponding to a photon energy of incident radiation, and includes: a holding portion that holds a first base substance and a second base substance having a larger attenuation coefficient for the radiation than the first base substance; and a moving mechanism that moves the holding portion in a body axis direction of a subject irradiated with the radiation to move each of the first base substance and the second base substance between a position within an irradiation field and a position outside the irradiation field.

### CROSS-REFERENCE TO RELATED APPLICATION

The present application claims priority under 35 U.S.C § 119 from Japanese Patent Application No. 2024-035388, filed on Mar. 7, 2024, the entire disclosure of which is incorporated herein by reference.

### BACKGROUND

### Technical Field

The present disclosure relates to a calibration device, a medical image capturing system, and a calibration method.

### Related Art

A photon-counting computed tomography (PCCT) apparatus comprising a photon-counting detector that is a detector adopting a photon-counting method is known. Since the photon-counting detector can measure a photon energy, which is an energy of an incident radiation photon, the PCCT apparatus can obtain a medical image in which substances having different compositions are discriminated, for example, a medical image in which an iodine contrast medium used in angiography and calcified plaque in a blood vessel are discriminated. In order to obtain a medical image in which substances are discriminated, the detector is calibrated. Therefore, for combinations of a plurality of base substances, which are substances having known compositions and thicknesses, a relationship between an output measured by the photon-counting detector and a photon energy is acquired in advance as calibration data for each detector element.

JP2013-146480A discloses acquiring calibration data from each of stepped phantoms made of acrylic and aluminum.

In a case where the stepped phantom described in JP2013-146480A is applied to a large irradiation field of about 50 cm, the phantom becomes heavy and difficult to handle, and it takes time to acquire calibration data of the photon-counting detector, which results in time and effort to acquire the calibration data.

### SUMMARY

The present disclosure has been made in consideration of the above circumstances, and an object of the present disclosure is to provide a calibration device, a medical image capturing system, and a calibration method that can easily acquire calibration data of a photon-counting detector.

In order to achieve the above object, a first aspect of the present disclosure provides a calibration device that is used to acquire calibration data of a photon-counting detector that outputs an electrical signal corresponding to a photon energy of incident radiation, the calibration device comprising: a holding portion that holds a first base substance and a second base substance having a larger attenuation coefficient for the radiation than the first base substance; and a moving mechanism that moves the holding portion in a body axis direction of a subject irradiated with the radiation to move each of the first base substance and the second base substance between a position within an irradiation field and a position outside the irradiation field.

A second aspect provides the calibration device according to the first aspect, in which the moving mechanism linearly moves the holding portion to move each of the first base substance and the second base substance between a position within the irradiation field and a position outside the irradiation field.

A third aspect provides the calibration device according to the first aspect, in which the holding portion includes a first holding member that holds the first base substance and a second holding member that holds the second base substance.

A fourth aspect provides the calibration device according to the third aspect, in which the holding portion includes a plurality of the first holding members and a plurality of the second holding members.

A fifth aspect provides the calibration device according to the third aspect, in which the first base substance has a plurality of measurement regions having different thicknesses in a direction in which the radiation is transmitted, and the moving mechanism moves the first base substance to a position within the irradiation field for each of the measurement regions.

A sixth aspect provides the calibration device according to the third aspect, in which the second base substance has a plurality of measurement regions having different thicknesses in a direction in which the radiation is transmitted, and the moving mechanism moves the second base substance to a position within the irradiation field for each measurement region.

A seventh aspect provides the calibration device according to the first aspect, in which each of the first base substance and the second base substance has a plurality of divided parts, and the moving mechanism moves the first base substance and the second base substance to a position within the irradiation field for each of the parts.

An eighth aspect provides the calibration device according to the first aspect, further comprising: a controller that performs control of causing the moving mechanism to move the first base substance and the second base substance to a position within the irradiation field according to a combination of the first base substance and the second base substance.

In order to achieve the above object, a ninth aspect of the present disclosure provides a medical image capturing system comprising: a radiation source; a photon-counting detector that outputs an electrical signal corresponding to a photon energy of radiation emitted from the radiation source; and the calibration device described in the present disclosure.

In order to achieve the above object, a tenth aspect of the present disclosure provides a calibration method of a photon-counting detector that outputs an electrical signal corresponding to a photon energy of incident radiation, the calibration method comprising: holding, by a holding portion, a first base substance and a second base substance having a larger attenuation coefficient for the radiation than the first base substance; moving, by a moving mechanism, the holding portion in a body axis direction of a subject irradiated with the radiation to move each of the first base substance and the second base substance between a position within an irradiation field and a position outside the irradiation field; and acquiring a plurality of pieces of calibration data obtained by varying a combination of the first base substance and the second base substance inserted into the irradiation field.

According to the present disclosure, it is possible to easily acquire calibration data of a photon-counting detector.

### BRIEF DESCRIPTION OF THE DRAWINGS

FIG. 1 is a configuration diagram showing an example of an overall configuration of a medical image capturing system according to an embodiment.

FIG. 2 is a diagram for describing an example of a calibration method of a detector panel, which is a photon-counting detector.

FIG. 3 is a configuration diagram showing an example of a configuration of a calibration device of the embodiment.

FIG. 4A is a diagram for describing movement of a first base substance.

FIG. 4B is a diagram for describing movement of a second base substance.

FIG. 5 is a configuration diagram showing an example of a configuration of a calibration device of Modification Example 1.

FIG. 6A is a diagram showing an example of the first base substance comprised in the calibration device of Modification Example 1.

FIG. 6B is a diagram showing an example of the second base substance comprised in the calibration device of Modification Example 1.

FIG. 7 is a diagram showing an example of the first base substance and the second base substance comprised in a calibration device of Modification Example 2.

### DETAILED DESCRIPTION

Hereinafter, embodiments of the present invention will be described in detail with reference to the drawings. The present embodiment does not limit the present invention.

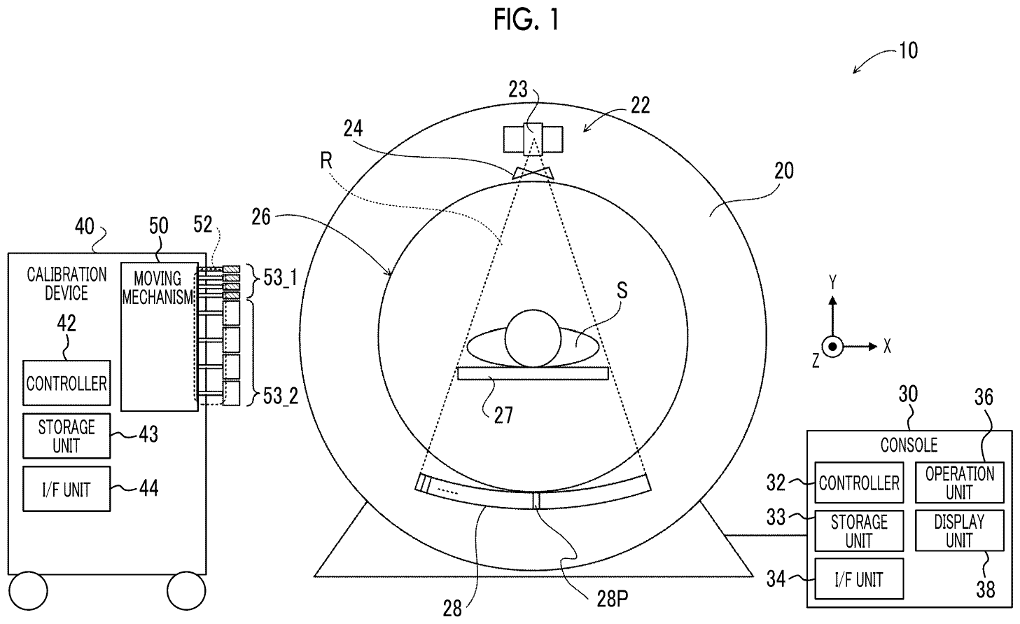

First, an example of an overall configuration of a medical image capturing system according to the present embodiment will be described. FIG. 1 is a configuration diagram showing an example of an overall configuration of a medical image capturing system 10 according to the present embodiment.

As shown in FIG. 1, the medical image capturing system 10 according to the present embodiment comprises a gantry 20, a bed 27, a console 30, and a calibration device 40. In the following description, a lateral direction in FIG. 1 is defined as an X-axis, a longitudinal direction is defined as a Y-axis, and a direction orthogonal to an XY plane is defined as a Z-axis.

The gantry 20 has an opening portion 26, and a subject S as an imaging target is disposed in the opening portion 26 in a state of being placed on the bed 27. The gantry 20 and the bed 27 are movable relative to each other in a Z-axis direction.

A radiation source 22 including a radiation tube 23 and a bowtie filter 24 and a detector panel 28 are disposed inside the gantry 20 in a state of facing each other with the subject S interposed therebetween. Radiation R emitted from the radiation tube 23 is shaped into a beam shape suitable for a size of the subject S by the bowtie filter 24 and irradiates the subject S. The detector panel 28 detects the radiation transmitted through the subject S and generates projection data according to a dose of the detected radiation. For example, the detector panel 28 of the present embodiment is a photon-counting detector in which a plurality of detection elements 28P that detect a photon energy, which is an energy of a photon of the incident radiation, are arranged in an arc shape centered on a focal point 23F of the radiation tube 23. The detector panel 28, which is a photon-counting detector, outputs projection data according to the photon energy.

The radiation tube 23 and the detector panel 28 are rotated around the subject S by a rotation drive unit (not shown) of the gantry 20. The radiation irradiation from the radiation tube 23 and the detection of the radiation by the detector panel 28 are repeated with the rotation of the radiation tube 23 and the detector panel 28, and thus projection data at various projection angles are acquired. A plurality of pieces of projection data acquired by the detector panel 28 are output to the console 30.

The dose of the radiation emitted from the radiation tube 23, a rotation speed of the gantry 20, a relative movement speed between the gantry 20 and the bed 27, and the like are set by the console 30 based on scan conditions input by a user, such as a technician.

The console 30 of the present embodiment performs control related to the acquisition of projection data, generation of a medical image, calibration of the detector panel 28 by the calibration device 40, and the like.

The console 30 comprises a controller 32, a storage unit 33, an interface (I/F) unit 34, an operation unit 36, and a display unit 38. The controller 32 comprises a central processing unit (CPU), a read only memory (ROM), a random access memory (RAM), and the like (all of which are not shown). For example, the console 30 of the present embodiment is a server computer.

The ROM stores in advance various programs executed by the CPU, including programs for performing the control related to the acquisition of projection data, generation of a medical image, calibration of the detector panel 28 by the calibration device 40, and the like. The RAM temporarily stores various types of data.

The storage unit 33 stores image data of the medical image, various other types of information, and the like. The storage unit 33 is implemented by, for example, a storage medium such as a hard disk drive (HDD), a solid state drive (SSD), and a flash memory.

The I/F unit 34 communicates various types of information with the rotation drive unit (not shown) of the gantry 20, the radiation source 22, the detector panel 28, and the calibration device 40 by wired communication or wireless communication. The console 30 of the present embodiment receives the projection data and calibration data 55 from the detector panel 28 via the I/F unit 34.

The operation unit 36 is used by the user to input scan conditions for acquiring the projection data, an instruction or various types of information related to the generation and display of an image, and the like. The operation unit 36 is not particularly limited, and examples thereof include various switches, buttons, a touch panel, a touch pen, a keyboard, and a mouse. The display unit 38 displays various types of information, medical images, and the like. The operation unit 36 and the display unit 38 may be integrated into a touch panel display. In addition, for example, the operation unit 36 may receive a voice input from the user.

The console 30 acquires a plurality of pieces of projection data from the detector panel 28 via the I/F unit 34. The controller 32 performs a reconstruction process on the acquired plurality of pieces of projection data to generate a tomographic image of the subject S. In a case where the plurality of pieces of projection data are image data acquired while the bed 27 and the gantry 20 are moved relative to each other in the Z-axis direction, the controller 32 generates a three-dimensional image of the subject S from the plurality of pieces of projection data. In the present embodiment, the projection data obtained by the detector panel 28, as well as the tomographic image and three-dimensional image generated by the controller 32, are collectively referred to as “medical images”.

The calibration device 40 of the present embodiment is a device for calibrating the entire medical image capturing system 10, mainly the detector panel 28. In the medical image capturing system 10 comprising the detector panel 28, which is a photon-counting detector, a photon energy spectrum related to the projection data of the subject S can be acquired. Therefore, a medical image in which substances having different compositions are discriminated or a medical image divided into a plurality of energy components can be generated. In order to obtain the medical image in which substances having different compositions are discriminated as described above, and the like, it is necessary to calibrate in advance a relationship between an output when a combination of a plurality of base substances, which are substances having known compositions and thicknesses, is measured by the detector panel 28 and the photon energy, for each of the detection elements 28P. The calibration device 40 is a device used for the calibration. The disposition and orientation of the calibration device 40 shown in FIG. 1 are for convenience of description, and are different from the disposition and orientation of the calibration device 40 in a case where the detector panel 28 is actually configured.

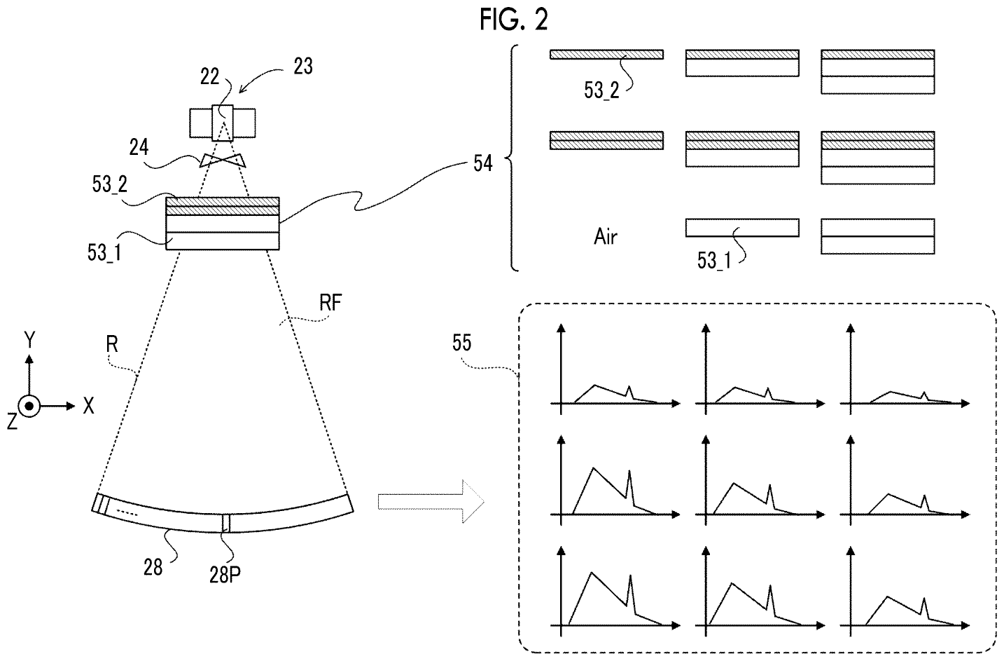

Here, an example of a calibration method of the detector panel 28, which is a photon-counting detector, will be described with reference to FIG. 2.

For the calibration of the detector panel 28, which is a photon-counting detector, a plurality of base substances having known compositions and thicknesses are used. In an example of the calibration shown in FIG. 2, two types of base substances, that is, a first base substance 53_1 and a second base substance 53_2, are used. The first base substance 53_1 and the second base substance 53_2 have different attenuation coefficients for radiation, and in the present embodiment, the second base substance 53_2 has a larger attenuation coefficient than the first base substance 53_1. For example, examples of the first base substance 53_1 include acrylic, and examples of the second base substance 53_2 include aluminum having a larger attenuation coefficient than acrylic.

In the example shown in FIG. 2, by combining two first base substances 53_1 having the same thickness and two second base substances 53_2 having the same thickness, the calibration data 55 is obtained for each of a plurality of combinations 54 of the first base substances 53_1 and the second base substances 53_2 having different thicknesses in a transmission direction of the radiation R. For example, in a case where the first base substance 53_1 has J types of thicknesses and the second base substance 53_2 has K types of thicknesses, J×K pieces of calibration data 55 are obtained by J×K types of combinations 54 of base substances.

Specifically, in the example shown in FIG. 2, assuming that a case where the first base substance 53_1 is not provided in an irradiation field RF is a case where the thickness of the first base substance 53_1 is “0 (zero)”, there are J=3 types of thicknesses of the first base substance 53_1. Similarly, assuming that a case where the second base substance 53_2 is not provided in the irradiation field RF is a case where the thickness of the second base substance 53_2 is “0 (zero)”, there are K=3 types of thicknesses of the second base substance 53_2. Therefore, in this case, there are 3×3=9 types of combinations of the base substances. In FIG. 2, “Air” corresponds to a case where neither the first base substance 53_1 nor the second base substance 53_2 is provided in the irradiation field RF, that is, a case where each of the first base substance 53_1 and the second base substance 53_2 has a thickness of “0 (zero)”.

Each of the nine types of combinations 54 is inserted into the irradiation field RF of the radiation R and irradiated with the radiation R from the radiation source 22, and the radiation R transmitted through the combination 54 is detected by the detector panel 28, so that a photon energy spectrum is acquired as the calibration data 55 for each combination 54. The nine types of calibration data 55 acquired in this way are output to the console 30, are stored in the storage unit 33 of the console 30, and are used for calibration of the projection data of the subject S.

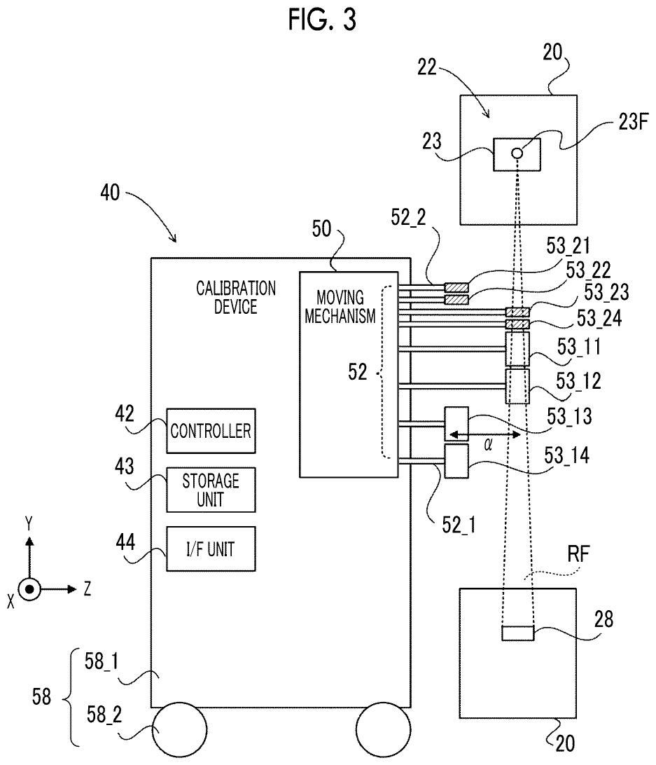

A configuration of the calibration device 40 of the present embodiment used for such calibration will be described with reference to FIGS. 1 and 3. The calibration device 40 of the present embodiment is configured as a carriage 58 having a housing 58_1 and a plurality of wheels 58_2, and comprises a controller 42, a storage unit 43, and an I/F unit 44 in the housing 58_1.

The controller 42 comprises a CPU, a ROM, a RAM, and the like (all of which are not shown). The ROM stores in advance various programs executed by the CPU, including programs for performing control related to acquisition of the calibration data 55. The RAM temporarily stores various types of data. The storage unit 43 stores various types of information and the like. The storage unit 43 is implemented by, for example, a storage medium such as an HDD, an SSD, and a flash memory. The I/F unit 44 communicates various types of information with the console 30 by wired communication or wireless communication. Specifically, the I/F unit 44 receives information related to the control for acquiring the calibration data 55 from the console 30.

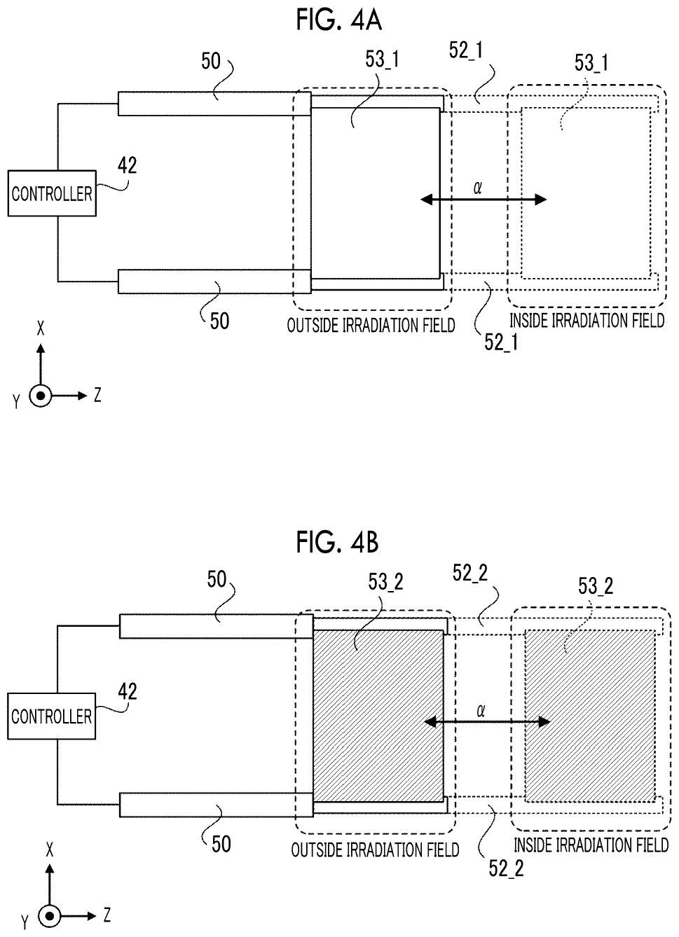

Furthermore, the calibration device 40 comprises a holding portion 52 and a moving mechanism 50. As shown in FIG. 3, the holding portion 52 includes a plurality of first holding members 52_1 and a plurality of second holding members 52_2. The calibration device 40 comprises four first base substances 53_1 (53_11 to 53_14), and the first holding members 52_1 respectively hold the first base substances 53_11 to 53_14. As an example, in the present embodiment, as shown in FIG. 4A, a pair of the first holding members 52_1 respectively hold a pair of opposite sides extending in the Z-axis direction of the first base substance 53_1 of which a surface (XZ surface in FIG. 4A) intersecting an irradiation direction of the radiation R is rectangular. In addition, the calibration device 40 comprises four second base substances 53_2 (53_21 to 53_24), and the second holding member 52_2 respectively hold the second base substances 53_21 to 53_24. As an example, in the present embodiment, as shown in FIG. 4B, a pair of the second holding members 52_2 respectively hold a pair of opposite sides extending in the Z-axis direction of the second base substance 53_2 of which a surface (XZ surface in FIG. 4B) intersecting the irradiation direction of the radiation R is rectangular. As shown in FIGS. 4A and 4B, one ends of the first holding member 52_1 and the second holding member 52_2 are connected to the moving mechanism 50 provided in the housing 58_1 of the carriage 58.

The moving mechanism 50 moves the holding portion 52 in a body axis direction of the subject S irradiated with the radiation R under the control of the controller 42 to move each of the first base substance 53_1 and the second base substance 53_2 between a position within the irradiation field RF and a position outside the irradiation field RF. In the present embodiment, as shown in FIGS. 3, 4A, and 4B, the moving mechanism 50 linearly moves each of the first holding member 52_1 and the second holding member 52_2 in an a direction along the Z-axis to move each of the first base substance 53_1 and the second base substance 53_2 between the position within the irradiation field RF and the position outside the irradiation field RF. FIG. 3 shows a state in which the first base substances 53_11 and 53_12 and the second base substances 53_23 and 53_24 are disposed at positions within the irradiation field RF and the first base substances 53_13 and 53_14 and the second base substances 53_21 and 53_22 are disposed at positions outside the irradiation field RF.

As the moving mechanism 50 capable of linearly moving the first holding member 52_1 and the second holding member 52_2 in the a direction, for example, a linear actuator or the like can be used.

Next, the calibration method of the detector panel 28 using the moving mechanism 50 of the present embodiment will be described. The calibration described here is performed in a state in which the gantry 20 is not rotated.

First, a person in charge of the calibration moves the carriage 58 to dispose the calibration device 40 at a predetermined position in front of the gantry 20. The predetermined position is a position at which the moving mechanism 50 can move the holding portion 52 to move the first base substance 53_1 and the second base substance 53_2 between the position within the irradiation field RF and the position outside the irradiation field RF of the radiation R.

After the calibration device 40 is disposed, the person in charge gives an instruction to perform the calibration via the operation unit 36 of the console 30. In a case where the instruction is received, the controller 32 of the console 30 instructs the calibration device 40 to acquire the calibration data 55 via the I/F unit 34.

In a case where the calibration device 40 receives the instruction to acquire the calibration data 55 from the console 30 via the I/F unit 44, the controller 42 instructs the moving mechanism 50 to move the first base substance 53_1 and the second base substance 53_2.

As described above, the calibration device of the present embodiment comprises the four first base substances 53_1 (53_11 to 53_14) and the four second base substances 53_2 (53_21 to 53_24). Therefore, including the case where the thickness of each of the first base substance 53_1 and the second base substance 53_2 is “0 (zero)”, 5×5=25 types of combinations 54 of the first base substances 53_1 and the second base substances 53_2 are obtained.

The controller 42 controls the moving mechanism 50 such that the first base substances 53_1 and the second base substances 53_2 are sequentially placed within the irradiation field RF according to the 25 types of combinations 54. The moving mechanism 50 moves at least one of the first holding member 52_1 or the second holding member 52_2 in the a direction under the control of the controller 42 to move the first base substances 53_1 and the second base substances 53_2 to the positions within the irradiation field RF of the opening portion 26 of the gantry 20.

In a case where the first base substances 53_1 and the second base substances 53_2 are moved to a state corresponding to any of the 25 types of combinations 54, the controller 42 transmits arrangement completion information indicating that the arrangement of the first base substances 53_1 and the second base substances 53_2 is completed, to the console 30 via the I/F unit 44. In a case where the console 30 receives the arrangement completion information from the calibration device 40 via the I/F unit 34, the console 30 instructs the radiation source 22 to perform the irradiation of the radiation R to acquire the calibration data 55. A radiation source controller (not shown) of the radiation source 22 irradiates the combination 54 disposed in the opening portion 26 of the gantry 20 with the radiation R from the radiation tube 23 in response to the irradiation instruction. The radiation R transmitted through the combination 54 is detected by the detector panel 28, and the calibration data 55 is acquired and output to the console 30.

The console 30 stores the calibration data 55 acquired from the detector panel 28 in the storage unit 33 in association with the type of the combination 54 used to acquire the calibration data 55.

In the medical image capturing system 10 according to the present embodiment, as described above, the 25 types of calibration data 55 are obtained by repeating the movement of the first base substances 53_1 and the second base substances 53_2 by the moving mechanism 50 of the calibration device 40, the emission of the radiation R from the radiation tube 23, and the detection of the radiation R by the detector panel 28. The controller 32 performs calibration of the detector panel 28 using the 25 types of calibration data 55. It should be noted that the calibration method of the detector panel 28 using the calibration data 55 is not limited, and a known method can be applied.

As described above, with the medical image capturing system 10 of the present embodiment, the detector panel 28 can be calibrated by using the calibration device 40. The technology of the present disclosure is not limited to the above-described embodiment, and may be modified as in Modification Examples 1 and 2 described below.

### Modification Example 1

In the above-described embodiment, in order to vary the thickness of each of the first base substance 53_1 and the second base substance 53_2 in the transmission direction of the radiation R, a form in which the calibration device 40 comprises the four first base substances 53_1 and the four second base substances 53_2 has been described. However, the numbers of the first base substance 53_1 and the second base substance 53_2 comprised in the calibration device 40 and the like are not limited to the above-described embodiment.

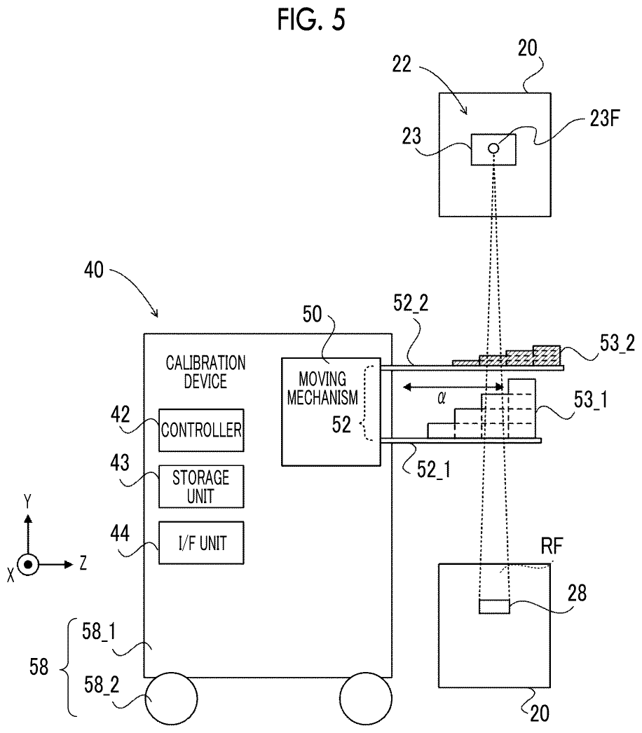

FIG. 5 is a configuration diagram of the calibration device 40 of the present modification example. The calibration device 40 of the present modification example is different from the calibration device 40 (see FIG. 3) of the above-described embodiment in that the calibration device 40 of the present modification example comprises one first base substance 53_1 and one second base substance 53_2.

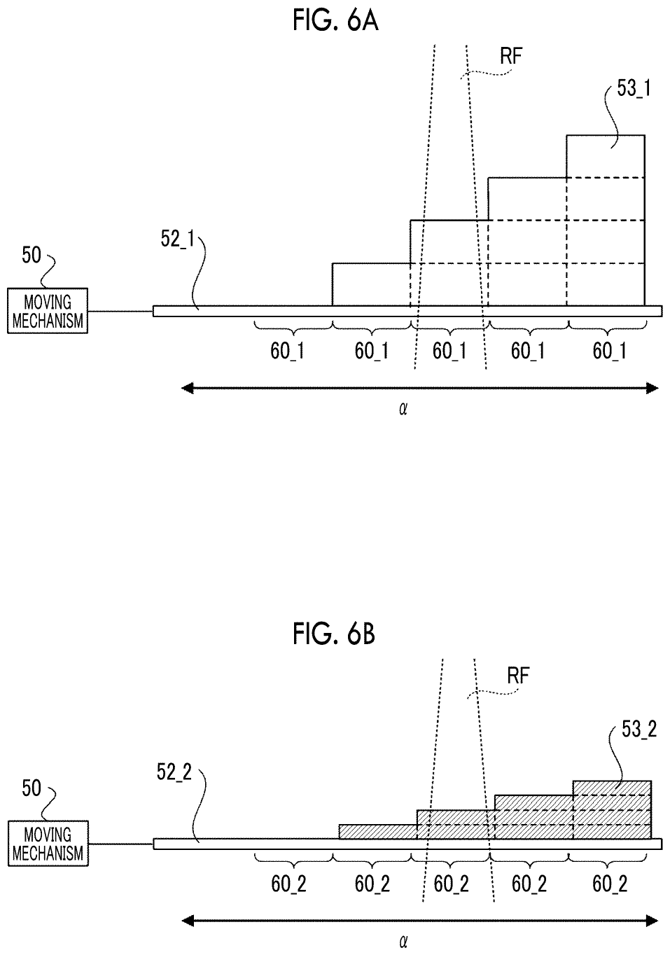

As shown in FIG. 6A, the first base substance 53_1 of the present modification example has five measurement regions 60_1 having different thicknesses in a direction in which the radiation R is transmitted. The moving mechanism 50 of the present modification example moves the first holding member 52_1 in the a direction to move the first base substance 53_1 to a position within the irradiation field RF for each measurement region 60_1.

In addition, as shown in FIG. 6B, the second base substance 53_2 of the present modification example has five measurement regions 60_2 having different thicknesses in the direction in which the radiation R is transmitted. The moving mechanism 50 of the present modification example moves the second holding member 52_2 in the a direction to move the second base substance 53_2 to a position within the irradiation field RF for each measurement region 60_2.

As described above, the calibration device 40 of the present modification example has the five measurement regions 60_1 in which the first base substance 53_1 has different thicknesses in the transmission direction of the radiation R, and has the five measurement regions 60_2 in which the second base substance 53_2 has different thicknesses in the transmission direction of the radiation R. Accordingly, with the calibration device 40 of the present modification example, it is possible to acquire 25 types of calibration data 55 in the same manner as the calibration device 40 (see FIG. 3) of the above-described embodiment.

Therefore, with the calibration device 40 of the present modification example, the numbers of the first holding members 52_1 and the second holding members 52_2 can be reduced, and the moving mechanism 50 can be reduced in size. For example, in a case where the linear actuator is provided for each of the first holding member 52_1 and the second holding member 52_2, the number of linear actuators comprised in the moving mechanism 50 can be suppressed.

### Modification Example 2

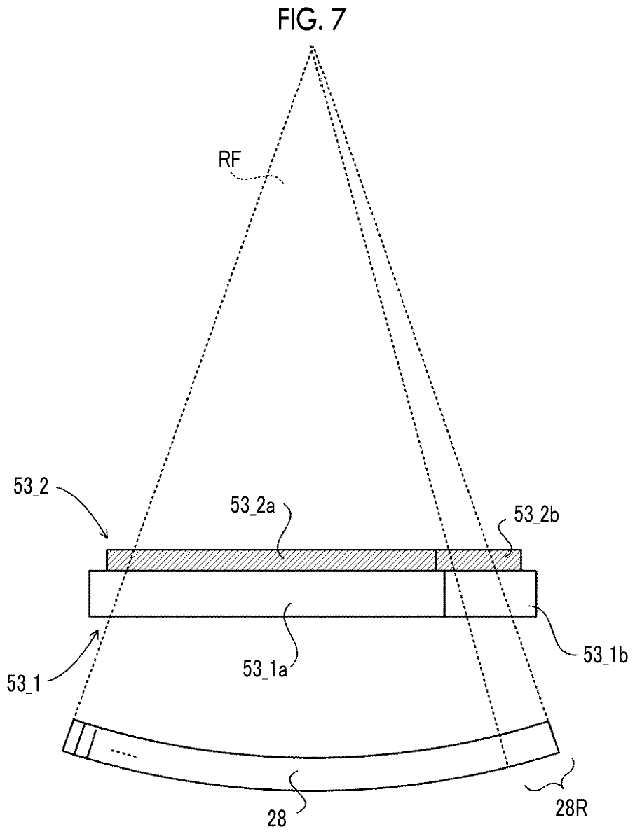

Each of the first base substance 53_1 and the second base substance 53_2 comprised in the calibration device 40 may have a plurality of divided parts. In an example shown in FIG. 7, the first base substance 53_1 has two divided parts, that is, a normal region 53_1a and a reference region 53_1b. In addition, the second base substance 53_2 has two divided parts, that is, a normal region 53_2a and a reference region 53_2b. The moving mechanism 50 moves the first base substance 53_1 and the second base substance 53_2 to a position within the irradiation field RF for each of the parts. In FIG. 7, one first base substance 53_1 and one second base substance 53_2 are shown, but a plurality of first base substances 53_1 and a plurality of second base substances 53_2 may be provided as in the above-described embodiment.

The reference regions 53_1b and 53_2b are regions corresponding to an irradiation field RF of the radiation R irradiating a reference detector 28R. In the present modification example, a predetermined number of the detection elements 28P at one end portion of the detector panel 28 are used as the reference detectors 28R. The reference detector 28R detects the radiation R that is not transmitted through the subject S and outputs a detection result as reference data. The controller 32 of the console 30 calibrates intensity levels of the radiation obtained by the other detection elements 28P based on an intensity of the radiation obtained by the reference data, and generates a tomographic image using a signal after the calibration.

In the calibration device 40 of the present modification example, each of the normal region 53_1a and the reference region 53_1b can be moved between a position within the irradiation field RF and a position outside the irradiation field RF by the moving mechanism 50. For example, a form in which the reference region 53_1b is held by a first holding member 52_1 different from the first holding member 52_1 that holds the normal region 53_1a may be adopted, and each first holding member 52_1 may be moved linearly by the moving mechanism 50. Similarly, a form in which the reference region 53_2b is held by a second holding member 52_2 different from the second holding member 52_2 that holds the normal region 53_2a may be adopted, and each second holding member 52_2 may be moved linearly by the moving mechanism 50.

In addition, a specific method of acquiring the calibration data 55 and the reference data in this case is not limited, but may be, for example, the following method. First, the controller 42 of the calibration device 40 causes the moving mechanism 50 to position both the normal region 53_1a and the reference region 53_1b within the irradiation field RF. The calibration data 55 is acquired in a state in which both the normal region 53_1a and the reference region 53_1b are positioned within the irradiation field RF. Next, the controller 42 causes the moving mechanism 50 to move the normal region 53_1a to a position outside the irradiation field RF. Reference data is acquired in a state in which only the reference region 53_1b is positioned within the irradiation field RF. A series of processes for acquiring the calibration data 55 and the reference data is performed for each combination 54.

As described above, according to the present modification example, the reference data can also be easily acquired by the calibration device 40.

In the present embodiment, the form in which one end portion (right end portion in FIG. 7) of the detector panel 28 is the reference detector 28R has been described, but the present invention is not limited to this form. For example, both end portions of the detector panel 28 may be used as the reference detector 28R. In this case, the first base substance 53_1 has three divided parts, that is, one normal region 53_1a and two reference regions 53_1b. In addition, the second base substance 53_2 has three divided parts, that is, one normal region 53_2a and two reference regions 53_2b.

As described above, the calibration device 40 of the above-described embodiment and each modification example is a calibration device used to acquire the calibration data 55 of the photon-counting detector panel 28 that outputs an electrical signal corresponding to the photon energy of the incident radiation R. The calibration device 40 comprises the holding portion 52 that holds the first base substance 53_1 and the second base substance 53_2 having a larger attenuation coefficient for the radiation R than the first base substance 53_1. In addition, the calibration device 40 comprises the moving mechanism 50 that moves the holding portion 52 in the body axis direction of the subject S irradiated with the radiation R to move each of the first base substance 53_1 and the second base substance 53_2 between a position within the irradiation field RF and a position outside the irradiation field RF.

For example, in a case of a calibration device using a stepped phantom as described in JP2013-146480A, unlike the calibration device 40 according to the above-described embodiment and each modification example, the number of steps increases according to the number of combinations of base substances required, and thus the entire calibration device becomes larger and heavier. Contrary to this, in the calibration device 40 of the above-described embodiment and each modification example, since the moving mechanism 50 moves the first base substance 53_1 and the second base substance 53_2 as described above, the entire calibration device 40 can be reduced in size. Therefore, with the calibration device 40 of the above-described embodiment and each modification example, the calibration data of the photon-counting detector can be easily acquired.

It should be noted that the configurations and operations of the medical image capturing system 10, the console 30, the calibration device 40, and the like described in the above-described embodiment and each modification example are merely examples, and it goes without saying that the configurations and operations can be changed according to the situation without departing from the spirit of the present invention. In addition, it goes without saying that the above-described embodiments may be appropriately combined.

Further, the following supplementary notes will be disclosed with respect to the above-described embodiments.

### Supplementary Note 1

A calibration device that is used to acquire calibration data of a photon-counting detector that outputs an electrical signal corresponding to a photon energy of incident radiation, the calibration device comprising: a holding portion that holds a first base substance and a second base substance having a larger attenuation coefficient for the radiation than the first base substance; and a moving mechanism that moves the holding portion in a body axis direction of a subject irradiated with the radiation to move each of the first base substance and the second base substance between a position within an irradiation field and a position outside the irradiation field.

### Supplementary Note 2

The calibration device according to supplementary note 1, in which the moving mechanism linearly moves the holding portion to move each of the first base substance and the second base substance between a position within the irradiation field and a position outside the irradiation field.

### Supplementary Note 3

The calibration device according to supplementary note 1 or 2, in which the holding portion includes a first holding member that holds the first base substance and a second holding member that holds the second base substance.

### Supplementary Note 4

The calibration device according to supplementary note 3, in which the holding portion includes a plurality of the first holding members and a plurality of the second holding members.

### Supplementary Note 5

The calibration device according to any one of supplementary notes 1 to 4, in which the first base substance has a plurality of measurement regions having different thicknesses in a direction in which the radiation is transmitted, and the moving mechanism moves the first base substance to a position within the irradiation field for each of the measurement regions.

### Supplementary Note 6

The calibration device according to any one of supplementary notes 1 to 4, in which the second base substance has a plurality of measurement regions having different thicknesses in a direction in which the radiation is transmitted, and the moving mechanism moves the second base substance to a position within the irradiation field for each measurement region.

### Supplementary Note 7

The calibration device according to any one of supplementary notes 1 to 6, in which each of the first base substance and the second base substance has a plurality of divided parts, and the moving mechanism moves the first base substance and the second base substance to a position within the irradiation field for each of the parts.

### Supplementary Note 8

The calibration device according to any one of supplementary notes 1 to 7, further comprising: a controller that performs control of causing the moving mechanism to move the first base substance and the second base substance to a position within the irradiation field according to a combination of the first base substance and the second base substance.

### Supplementary Note 9

A medical image capturing system comprising: a radiation source; a photon-counting detector that outputs an electrical signal corresponding to a photon energy of radiation emitted from the radiation source; and the calibration device according to any one of supplementary notes 1 to 8.

### Supplementary Note 10

A calibration method of a photon-counting detector that outputs an electrical signal corresponding to a photon energy of incident radiation, the calibration method comprising: holding, by a holding portion, a first base substance and a second base substance having a larger attenuation coefficient for the radiation than the first base substance; moving, by a moving mechanism, the holding portion in a body axis direction of a subject irradiated with the radiation to move each of the first base substance and the second base substance between a position within an irradiation field and a position outside the irradiation field; and acquiring a plurality of pieces of calibration data obtained by varying a combination of the first base substance and the second base substance inserted into the irradiation field.

### EXPLANATION OF REFERENCES

10: medical image capturing system
20: gantry
22: radiation source
23: radiation tube, 23F: focal point
24: bowtie filter
26: opening portion
27: bed
28: detector panel, 28P: detection element, 28R: reference detector
30: console
32, 42: controller
33, 43: storage unit
34, 44: I/F unit
36: operation unit
38: display unit
40: calibration device
50: moving mechanism
52: holding portion, 52_1: first holding member, 52_2: second holding member
53_1, 53_11 to 53_14: first base substance, 53_1a: normal region, 53_1b: reference region, 53_2, 53_21 to 53_24: second base substance, 53_2a: normal region, 53_2b: reference region
54: combination
55: calibration data
58: carriage, 58_1: housing, 58_2: wheel
60_1, 60_2: measurement region
R: radiation, RF: irradiation field
S: subject
α: direction

What is claimed is:

1. A calibration device that is used to acquire calibration data of a photon-counting detector that outputs an electrical signal corresponding to a photon energy of incident radiation, the calibration device comprising:
a holding portion that holds a first base substance and a second base substance having a larger attenuation coefficient for the radiation than the first base substance; and
a moving mechanism that moves the holding portion in a body axis direction of a subject irradiated with the radiation to move each of the first base substance and the second base substance between a position within an irradiation field and a position outside the irradiation field.

2. The calibration device according to claim 1, wherein the moving mechanism linearly moves the holding portion to move each of the first base substance and the second base substance between a position within the irradiation field and a position outside the irradiation field.

3. The calibration device according to claim 1, wherein the holding portion includes a first holding member that holds the first base substance and a second holding member that holds the second base substance.

4. The calibration device according to claim 3,
wherein the holding portion includes a plurality of the first holding members and a plurality of the second holding members.

5. The calibration device according to claim 3, wherein:
the first base substance has a plurality of measurement regions having different thicknesses in a direction in which the radiation is transmitted, and
the moving mechanism moves the first base substance to a position within the irradiation field for each of the measurement regions.

6. The calibration device according to claim 3, wherein:
the second base substance has a plurality of measurement regions having different thicknesses in a direction in which the radiation is transmitted, and
the moving mechanism moves the second base substance to a position within the irradiation field for each measurement region.

7. The calibration device according to claim 1, wherein:
each of the first base substance and the second base substance has a plurality of divided parts, and
the moving mechanism moves the first base substance and the second base substance to a position within the irradiation field for each of the parts.

8. The calibration device according to claim 1, further comprising a controller that performs control of causing the moving mechanism to move the first base substance and the second base substance to a position within the irradiation field according to a combination of the first base substance and the second base substance.

9. A medical image capturing system comprising:
a radiation source;
a photon-counting detector that outputs an electrical signal corresponding to a photon energy of radiation emitted from the radiation source; and
the calibration device according to claim 1.

10. A calibration method of a photon-counting detector that outputs an electrical signal corresponding to a photon energy of incident radiation, the calibration method comprising:
holding, by a holding portion, a first base substance and a second base substance having a larger attenuation coefficient for the radiation than the first base substance;
moving, by a moving mechanism, the holding portion in a body axis direction of a subject irradiated with the radiation to move each of the first base substance and the second base substance between a position within an irradiation field and a position outside the irradiation field; and
acquiring a plurality of pieces of calibration data obtained by varying a combination of the first base substance and the second base substance inserted into the irradiation field.
